(19) United States
(12) Patent Application Publication
(10) Pub. No.: US 2001/0017362 A1
(43) Pub. Date: Aug. 30, 2001

(54) Flap valve for liquid containers and liquid conduits

(76) Inventor: Udo Schutz, Selters (DE)

Correspondence Address: FRIEDRICH KUEFFNER, SUITE 1921, 342 MADISON AVENUE, NEW YORK, NY, 10173, US

(21) Appl. No.: 09/732,999

(22) Filed: Dec. 8, 2000

(30) Foreign Application Priority Data
Dec. 9, 1999 (DE) 199 59 367.1

(51) Int. Cl. F16K 1/22

(52) U.S. Cl. 251/306

(57) ABSTRACT

A flap valve for liquid containers and liquid conduits has a valve housing having a cylindrical through bore extending in a longitudinal direction of the valve housing. A circular flap is positioned in the through bore and arranged in the valve housing rotatably about an axis extending perpendicularly to the longitudinal direction. A grip is located external to the housing and connected to the circular flap, wherein the grip is configured to turn the circular flap for opening and closing the through bore depending on a position of the circular flap. The throughbore has a seat having a spherical geometry for receiving the circular flap in a closed position of the circular flap.

### BACKGROUND OF THE INVENTION

1. Field of the Invention

The invention relates to a flap valve for liquid containers and liquid conduits.

2. Description of the Related Art

Such a flap valve is designed, in particular, as a dispensing fixture for being connected to the outflow socket or the outflow opening of a transport and storage container for liquids. The flap valve comprises a valve housing in which a circular flap, actuatable by a grip, for opening and closing a cylindrical through bore is supported rotatably about an axis which extends perpendicularly to the longitudinal axis of the through bore. Such a flap valve is disclosed in German patent document DE 198 15 082 A1.

### SUMMARY OF THE INVENTION

It is an object of the present invention to improve the functional reliability and safety of the flap valve of the aforementioned kind.

In accordance with the present invention, this is achieved in that the through bore of the valve housing has a seat having a spherical geometry for the circular flap in its closed position.

The spherical geometry of the seat for the circular flap in its closed position within the through bore of the housing of the flap valve according to the invention allows a seal-tight closing of the flap valve across a certain pivot range of the circular flap relative to its precise closed position transverse to the longitudinal axis of the through bore of the valve housing and ensures thus a high functional reliability and safety of the flap valve. Moreover, the flap valve can be easily cleaned during maintenance and servicing.

### BRIEF DESCRIPTION OF THE DRAWING

In the drawing:

FIG. 1 is an end view of the flap valve according to the present invention;

FIG. 2 is a longitudinal section of the flap valve according to the present invention; and

FIG. 3 is a cross-section of the flap valve in the closed position along section line III-III of FIG. 1.

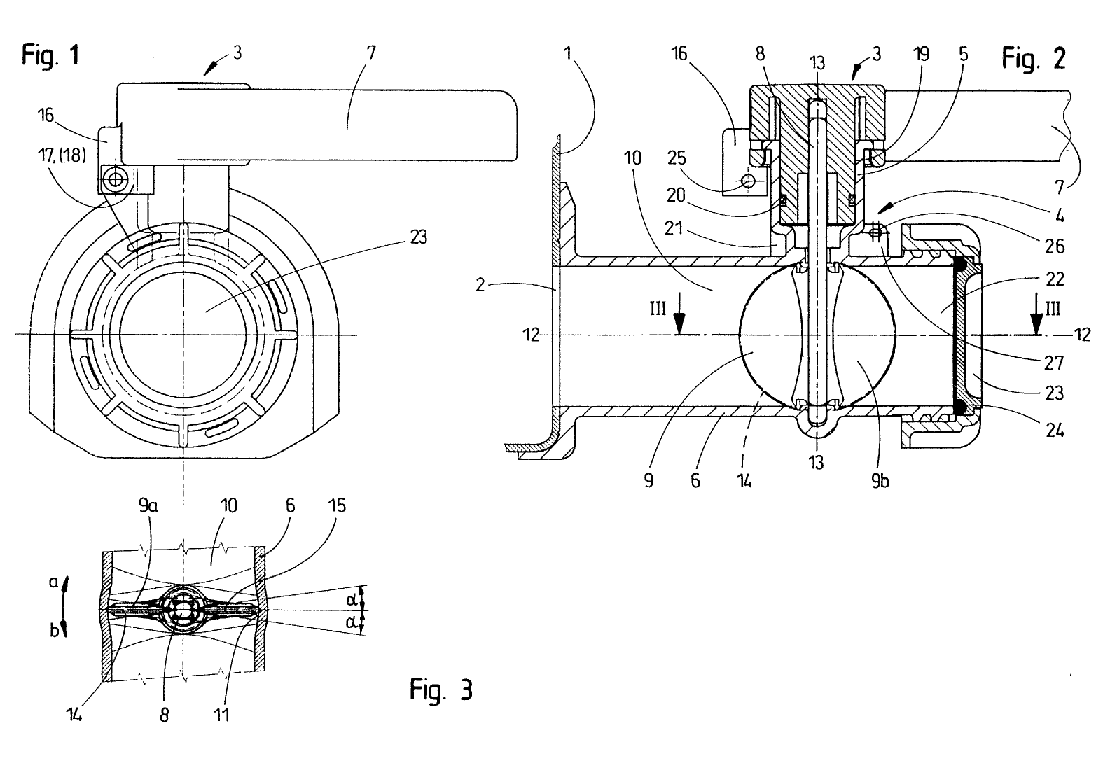

### DESCRIPTION OF THE PREFERRED EMBODIMENTS

The main components of the flap valve 3, to be connected directly to the outflow opening 2 of a liquid container 1 or to its outflow socket (not illustrated), are the following: a monolithic valve housing 4 which is injection-molded of plastic material and comprises a top part 5 and a bottom part 6, a grip 7 which is rotatably supported in the top part 5 of the valve housing 4 for actuation of a shaft 8 which is rotatably supported in the top part 5 and the bottom part 6 of the valve housing 4, and a circular flap 9, fastened to the shaft 8, for opening and closing a cylindrical through bore 10 in the bottom part 6 of the valve housing 4.

The through bore 10 of the valve housing 4 forms a seat 11 with a spherical geometry for the circular flap 9 in its closed position, the circular flap 9 being rotatable about the axis 13-13 extending perpendicularly to the longitudinal axis 12-12 of the through bore 10.

The spherical geometry of the seat 11 allows a closing range for the circular flap 9 about a pivot angle a deviating from the precise closed position 9a of the circular flap 9, positioned at a right angle to the longitudinal axis 12-12 of the through bore 10 of the valve housing 4, in both pivot directions a, b by a magnitude of 5 to 10°. In this closing range, the flap valve 3 provides an optimal closing function. This has the advantage that the flap valve still closes tightly even when its closed position has not been precisely adjusted due to inattentiveness.

The circular flap 9, injection-molded of a plastic material, has a circumferential groove 14 into which a sealing ring 15 of plastic material is injection-molded. The plastic material of the sealing ring 15 is harder than the plastic material of the valve housing 4.

The grip 7 is provided with a stop 16 formed integrally thereat. The stop 16 interacts with two counter stops 17, 18 on the top part 5 of the valve housing 4, which define the closed position 9a and the open position 9b of the circular flap 9 of the flap valve 3.

The top part 5 has a rotary bearing 19 for the grip 7 which is sealed by an O-ring 20. The top part 5 tapers at its lower end and is supported by stays 21 on the bottom part 6 of the valve housing. The shaft 8, which is connected to the grip 7 for pivoting the circular flap 9 of the flap-valve 3, is manufactured of a glass fiber-reinforced plastic material. This constructive measure contributes to an increase of the drop stability of the flap valve which is important in connection with furnishing transport and storage containers for liquids with such a flap valve.

The outflow opening 22 of the flap valve 3 can be closed off with a screw cap 23 having an inserted O-ring 24.

When providing the liquid container with the flap valve according to the invention, the holes 25, 26 within the stop 16 of the grip 7 and in the projection 27 of the valve housing 4 can be used to attach a safety seal against tampering and as an indicator of an original packaging.

While specific embodiments of the invention have been shown and described in detail to illustrate the inventive principles, it will be understood that the invention may be embodied otherwise without departing from such principles.

What is claimed is:

1. A flap valve for liquid containers and liquid conduits, the flap valve comprising:
a valve housing having a cylindrical through bore extending in a longitudinal direction of the valve housing;
a circular flap positioned in the through bore and arranged in the valve housing rotatably about an axis extending perpendicularly to the longitudinal direction;
a grip located external to the housing and connected to the circular flap, wherein the grip is configured to turn the circular flap for opening and closing the through bore depending on a position of the circular flap;
the throughbore having a seat having a spherical geometry configured to receive the circular flap in a closed position of the circular flap.

2. The flap valve according to claim 1, wherein the seat has an angular closing range for the closed position of the circular flap.

3. The flap valve according to claim 1, wherein the circular flap is an injection-molded plastic part and has a circumferential groove, wherein the circular flap comprises a sealing ring injection-molded into the circumferential groove.

4. The flap valve according to claim 3, wherein the valve housing is a monolithic, injection-molded plastic part.

5. The flap valve according to claim 4, wherein the plastic material of the sealing ring is harder than the plastic material of the valve housing.

6. The flap valve according to claim 1, wherein the valve housing has a reinforced top part.

7. The flap valve according to claim 1, configured as a dispensing fixture configured to be connected to an outflow socket or an outflow opening of a transport and storage container for liquids.
